(19) United States
(12) Patent Application Publication
(10) Pub. No.: US 2024/0008077 A1
(43) Pub. Date: Jan. 4, 2024

(54) METHOD FOR SIDELINK COMMUNICATION AND TERMINAL DEVICE

(71) Applicant: Lenovo (Beijing) Limited, Beijing (CN)

(72) Inventors: Jing Han, Beijing (CN); Ran Yue, Beijing (CN); Lianhai Wu, Beijing (CN); Min Xu, Beijing (CN); Haiming Wang, Beijing (CN); Jie Shi, Beijing (CN)

(73) Assignee: Lenovo (Beijing) Limited, Beijing (CN)

(21) Appl. No.: 18/264,294

(22) PCT Filed: Feb. 8, 2021
(86) PCT No.: PCT/CN2021/076083

§ 371 Date: Aug. 4, 2023

(51) Int. Cl. H04W 74/08

(52) U.S. Cl. CPC H04W 74/0808; H04W 92/18

(57) ABSTRACT

Embodiments of the present disclosure relate to a solution for supporting an LBT mechanism for sidelink transmissions. In a method for communication, a terminal device starts a listen-before-talk (LBT) procedure. The terminal device generates an LBT failure indication if a channel for a side Link transmission is occupied during the LBT procedure. If the number of LBT failure indications is equal to or greater than a predetermined number threshold, the terminal device determines a consistent LBT failure associated with the sidelink transmission. In this way, the sidelink transmission associated with the terminal device can coexist with other transmissions based on other wireless technologies, for example, on an unlicensed band.

### FIELD

Embodiments of the present disclosure generally relate to the field of communication, and in particular to a method for sidelink communication and a terminal device.

### BACKGROUND

5G New Radio (NR) is the 5th generation mobile network. It is a new global wireless standard after 1G, 2G, 3G, and 4G networks. 5G NR enables a new kind of network that is designed to connect virtually everyone and everything together including machines, objects, and devices. 5G wireless technology intends to deliver higher multi-Gbps peak data speeds, ultra-low latency, more reliability, massive network capacity, increased availability, and a more uniform user experience to more users. Higher performance and improved efficiency effectively improve user experiences and connect new industries.

In NRU (NR on Unlicensed band), to coexist with other wireless technologies on unlicensed band for example WiFi system, a listen-before-talk (LBT) procedure is performed before each transmission to occupy the channel. If LBT is failed, which means the channel is already occupied, corresponding transmission will be dropped and an LBT failure indication is sent to the media access control (MAC) entity from lower layers. Then MAC layer will count the number of LBT failure indication in timer period, and trigger consistent LBT failure if condition is fulfilled. However, for the case that a sidelink transmission between two terminal devices is operated in an unlicensed band, conventional mechanisms are less possible to enable the sidelink transmission to coexist with other wireless technologies.

### SUMMARY

In general, embodiments of the present disclosure provide a solution for supporting an LBT mechanism for sidelink transmissions.

In a first aspect, there is provided a method performed by a terminal device. The method comprises starting a listen-before-talk (LBT) procedure. The method also comprises generating an LBT failure indication if a channel for a sidelink transmission is occupied during the LBT procedure. The method further comprises in response to the number of LBT failure indications being equal to or greater than a predetermined number threshold, determining a consistent LBT failure associated with the sidelink transmission.

In a second aspect, there is provided a terminal device. The first terminal device comprises a processor and a memory storing instructions. The memory and the instructions are configured, with the processor, to cause the terminal device to perform the method of the first aspect.

In a third aspect, there is provided a computer readable medium. The computer readable medium has instructions stored thereon. The instructions, when executed on at least one processor of a device, causing the device to perform the method of the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates a flowchart of an example method for communication in accordance with some embodiments of the present disclosure;

FIG. 3A illustrates an example of a control element for indicating consistent LBT failures per resource pool in accordance with some embodiments of the present disclosure;

FIG. 3B illustrates a further example of a control element for indicating consistent LBT failures per resource pool in accordance with some embodiments of the present disclosure; and

FIG. 4 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As mentioned above, if a sidelink transmission between two terminal devices is operated in unlicensed band, there is no suitable mechanism to enable the sidelink transmission to coexist with other wireless technologies. It is possible that in the future, sidelink is also operated on unlicensed band, for example for public safety scenario or commercial sidelink scenario. In this case, LBT mechanism in NRU may need to be introduced to coexist with other wireless systems on unlicensed band. Before each sidelink transmission, sidelink (SL) UE may need to perform LBT and drop the sidelink transmission if the LBT is failed. In addition, the MAC layer can count the number of LBT failure indications and detect a consistent LBT failure. However, legacy schemes do not consider sidelink specific issues.

In order to solve the above-identified technical problems as well as potentially other technical problems found in the traditional solutions, embodiments of the present disclosure provide a solution for supporting an LBT mechanism for sidelink transmissions. In one aspect of the solution of the present disclosure, a terminal device starts a listen-before-talk (LBT) procedure. If a channel for a sidelink transmission is occupied during the LBT procedure, the terminal device generates an LBT failure indication. If the number of LBT failure indications is equal to or greater than a predetermined number threshold, the terminal device determines a consistent LBT failure associated with the sidelink transmission. Through the proposed solution, sidelink communications between terminal devices can coexist with other communications based on other wireless technologies, for example, on an unlicensed band. Principles and implementations of embodiments of the present disclosure will be described in detail below with reference to the figures.

### Example Environment

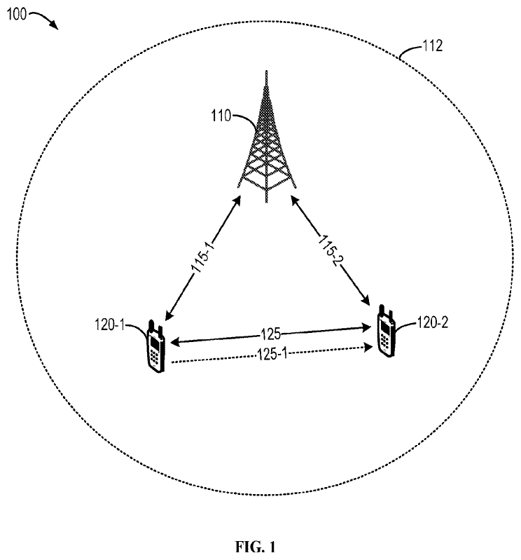

FIG. 1 illustrates a schematic diagram of a communication environment 100 in which some embodiments of the present disclosure can be implemented. As shown in FIG. 1, the communication environment 100, which may also be referred to as a communication network 100 or a communication system 100, includes a network device 110, a terminal device 120-1 and a terminal device 120-2. The network device 110 manages a cell 112 and serves the terminal device 120-1 and the terminal device 120-2 in the cell 112. To transmit data and/or control information, the terminal device 120-1 and the terminal device 120-2 can perform communications with the network device 110, respectively.

In particular, as illustrated in the exemplary scenario of FIG. 1, the terminal device 120-1 may communicate with the network device 110 via a communication link 115-1, and the terminal device 120-2 may communicate with the network device 110 via a communication channel 115-2. For transmissions from the network device 110 to the terminal device 120-1 or 120-2, the communication link 115-1 or 115-2 may be referred to as a downlink, whereas for transmissions from the terminal device 120-1 or 120-2 to the network device 110, the communication link 115-1 or 115-2 may alternatively be referred to as an uplink.

In addition to the communication links 115-1 and 115-2, the terminal device 120-1 and the terminal device 120-2 can perform a sidelink transmission, which is also referred to as a device-to-device (D2D) communication, via a sidelink 125 between the terminal device 120-1 and the terminal device 120-2. For example, in the exemplary scenario of FIG. 1, the first terminal device 120-1 is to perform a sidelink transmission 125-1 to the terminal device 120-2 via the sidelink 125. In some embodiments, the sidelink transmission 125-1 may be performed in an unlicensed band in which various wireless devices based on different wireless technologies share the same wireless spectrum.

As used herein, the term “sidelink transmission” generally refers to any transmission performed from one terminal device to another terminal device. The sidelink transmission may be used for transmitting any data or control information associated with sidelink communications, for example, sidelink data, sidelink control information, sidelink feedback information, or the like. As used herein, the term “sidelink channel” may generally refer to any channel used for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

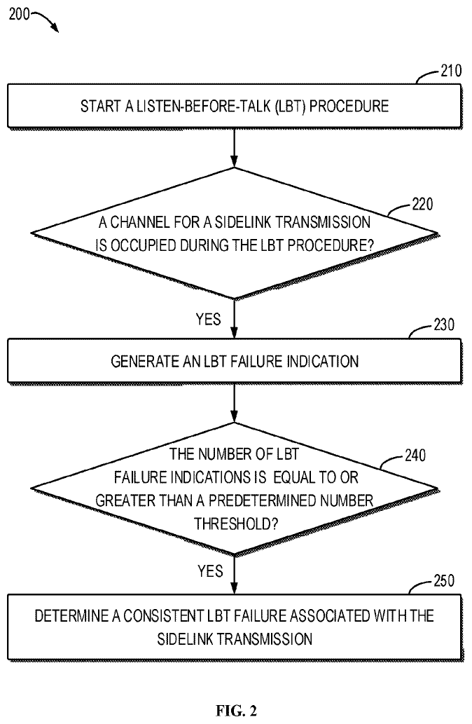

Channel access in the sidelink can rely on the so-called LBT feature, in which before performing the sidelink transmission 125-1, the terminal device 120-1 can first “sense” a communication channel to find out there are no communications on the communication channel prior to any transmission on the communication channel. For example, the “channel sensing” procedure may rely on detecting the energy level on the communication channel. The LBT parameters (such as type/duration, clear channel assessment parameters, and the like) can be configured in the terminal device 120-1, for example, by the network device 110. More details of the LBT procedure before a sidelink transmission will be detailed later with reference to FIG. 2.

In some embodiments, the network device 110 may be absent in the communication environment 100. For example, one or more of the terminal devices 120-1 and 120-2 as well as other terminal devices (not shown) may be outside of the coverage range (namely, outside of the cell 112) of the network device 110. In such cases, only sidelink communications may exist between one or more of the terminal devices 120-1, 120-2 and possibly other terminal devices not shown in FIG. 1 that may be outside the cell 112.

Although the network device 110 and the terminal devices 120-1, 120-2 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the network device 110 is schematically depicted as a base station and the terminal devices 120 are schematically depicted as mobile phones in FIG. 1, it is understood that these depictions are exemplary in nature without suggesting any limitation. In other embodiments, the network device 110 and the terminal devices 120 may be any other communication devices, for example, any other wireless communication devices.

In case the terminal devices 120-1 and 120-2 are vehicle-mounted terminal devices, communication relate to them may be referred to as a V2X communication. More generally, although not shown in FIG. 1, the V2X communication related to the terminal devices 120 may comprise a communication channel between the first or second terminal devices 120-1 or 120-2, respectively, and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the particular number of various communication devices, the particular number of various communication links, the particular number of other elements, and the particular shape of the cell 112 as shown in FIG. 1 is for illustration purpose only without suggesting any limitations. The communication environment 100 may include any suitable number of communication devices, any suitable number of communication links, any suitable number of other elements and any suitable shape of the cell 112 adapted for implementing embodiments of the present disclosure. In addition, it should be appreciated that there may be various wireless as well as wireline communications (if needed) among all of the communication devices.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, such communication may utilize any appropriate wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Method

FIG. 2 illustrates a flowchart of an example method 200 for communication in accordance with some embodiments of the present disclosure. In some embodiments, the method 200 can be implemented at a device in a communication network, such as the terminal device 120-1 as shown in FIG. 1. Additionally or alternatively, the method 200 can be implemented at other devices shown in FIG. 1. In some other embodiments, the method 200 may be implemented at devices not shown in FIG. 1. Further, it is to be understood that the method 200 may include additional blocks not shown and/or may omit some blocks as shown, and the scope of the present disclosure is not limited in this regard. For the purpose of discussion, the method 200 will be described from the perspective of the terminal device 120-1 with reference to FIG. 1.

At block 210, before performing the sidelink transmission 125-1, the terminal device 120-1 starts an LBT procedure. In New Radio in Unlicensed Spectrum (NR-U), channel accesses in both downlink and uplink rely on the LBT feature. For example, with reference to FIG. 1A, if the communication system 100 is implemented in NR-U, the network device 110 or the terminal device 120 must first “sense” a communication channel to find out there is no communications on the communication channel prior to any transmission on the communication channel. When a communication channel is a wide bandwidth unlicensed carrier (for example, several hundreds of MHz), the “channel sensing” procedure may rely on detecting the energy level on multiple sub-bands of the communication channel. The LBT parameters (such as type/duration, clear channel assessment parameters, and the like) can be configured in the terminal device 120 by the network device 110.

Accordingly, if the sidelink transmission 125-1 for example is to be performed in an unlicensed band, the terminal device 120-1 can similarly perform an LBT procedure for the sidelink transmission 125-1. In some embodiments, the LBT procedure for the sidelink transmission 125-1 may be largely similar to the LBT procedures for the downlink and uplink transmissions in an unlicensed band. However, since the characteristic of a sidelink transmission may be different from that of a downlink or uplink transmission, there may be some differences between the LBT procedure for a sidelink transmission in accordance with embodiments of the present disclosure and the conventional LBT procedures for the downlink and uplink transmissions. Such differences will be further detailed hereinafter.

At block 220, the terminal device 120-1 determines whether a channel for the sidelink transmission 125-1 is occupied during the LBT procedure. For example, if the terminal device 120-1 detects that the energy level on the channel is higher than or equal to a threshold energy level, then the terminal device 120-1 can determine that the channel for the sidelink transmission 125-1 is occupied. Otherwise, if the terminal device 120-1 detects that the energy level on the channel is lower than the threshold energy level, the terminal device 120-1 can determine that the channel for the sidelink transmission 125-1 is not occupied.

At block 230, if the terminal device 120-1 determines that the channel for the sidelink transmission 125-1 is occupied during the LBT procedure, the terminal device 120-1 generates an LBT failure indication. For example, it is assumed that the lower layer of the terminal device 120-1 performs the LBT procedure, according to which the sidelink transmission 125-1 is not performed by lower layers if the channel is identified as being occupied. When the lower layer performs the LBT procedure before the sidelink transmission 125-1 and the sidelink transmission 125-1 is not performed, an LBT failure indication can be sent to the MAC entity of the terminal device 120-1 from the lower layer.

At block 240, the terminal device 120-1 determines whether the number of LBT failure indications is equal to or greater than a predetermined number threshold. In some embodiments, the terminal device 120-1 can determine the number of LBT failure indications within a predetermined time duration. For example, the terminal device 120-1 can be configured with a counter and a timer for the sidelink consistent LBT failure detection. In other words, the counter can count the number of LBT failure indications and the timer can represent the predetermined time duration. If a sidelink LBT failure indication has been generated by the terminal device 120-1, the terminal device 120-1 can start or restart the timer and increase the counter accordingly.

For instance, if a sidelink LBT failure indication has been received from a lower layer of the terminal device 120-1, a higher layer (for example, the MAC entity) of the terminal device 120-1 can start or restart the timer and increment the counter by one (1). By starting or restarting the timer and incrementing the counter, the terminal device 120-1 can count the number of LBT failure indications within the predetermined time duration. In some embodiments, the timer can be referred to as Sidelink-LBT-FailureDetectionTimer and can be configured by the RRC. Similarly, the counter can be referred to as Sidelink-LBT-Counter.

In addition, in some embodiments, the terminal device 120-1 can be configured with a maximum count for the sidelink consistent LBT failure detection. In other words, the maximum count can represent the predetermined number threshold. Accordingly, by comparing the value of the counter and the maximum count, the terminal device 120-1 can determine whether or not the number of LBT failure indications is equal to or greater than the predetermined number threshold.

At block 250, if the terminal device 120-1 determines that the number of LBT failure indications is equal to or greater than the predetermined number threshold, the terminal device 120-1 determines a consistent LBT failure associated with the sidelink transmission 125-1. For example, in some situations, the terminal device 120-1 can identify that the value of the counter is equal to or greater than the maximum count. Thus, in these situations, the terminal device 120-1 can determine that the number of LBT failure indications is equal to or greater than the predetermined number threshold. Then, the terminal device 120-1 can determine that a consistent LBT failure has been detected associated with the sidelink transmission 125-1.

As can be seen from embodiments described with reference to FIG. 2, a method of consistent LBT failure for sidelink unlicensed transmission is proposed. The method can be used by the terminal device 120-1 to detect consistent SL LBT failures. Through the solution of the present disclosure, sidelink communications between terminal devices can coexist with other communications based on other wireless technologies, for example, on an unlicensed band.

Hereinbefore, some embodiments of the LBT mechanism for sidelink transmissions are described in general terms. Hereinafter, some more embodiments of the LBT mechanism for sidelink transmissions will be further detailed in regard to various specific aspects.

The first specific aspect of the LBT mechanism for sidelink transmissions is the detection granularity of the consistent LBT failure. As a reference, the detection granularity of the conventional consistent LBT failure in uplink is per Sidelink Bandwidth Part (SL-BWP). For the sidelink transmissions, in addition to the BWP, there are other possible granularities, for example, the resource pool (RP), the cast type, the destination, the unicast link, and the like. Among these granularities, the resource pool can be more suitable for consistent LBT failure detection since it is resource specific granularity. In general, a resource pool for sidelink transmissions can be considered as a set of transmission resources that can be used by a terminal device to perform a sidelink transmission. For example, in a first mode (also referred to as Mode 1) of sidelink transmissions, the network device 110 can configure a resource from the resource pool for the terminal device 120 to perform the sidelink transmission. Alternatively, in a second mode (also referred to as Mode 2) of sidelink transmissions, the terminal device 120-1 can select a resource from the resource pool for performing the sidelink transmission.

In some embodiments, the terminal device 120-1 can be configured with one or more resource pools for performing the sidelink transmission 125-1. In this event, when determining the number of LBT failure indications, the terminal device 120-1 can count the number of LBT failure indications per resource pool. In other words, the terminal device 120-1 may count the number of LBT failure indications of one or more resource pools of the terminal device 120-1. For example, if multiple resource pools are configured for the terminal device 120-1 to perform the sidelink transmission 125-1, then the number of LBT failure indications can be counted separately for individual resource pools. In this way, a novel solution is proposed for sidelink LBT failures, especially, for resource pools based consistent sidelink LBT failure.

In an implementation where consistent LBT failure is detected based on transmission resource pool, SL LBT failure indication is counted per-Tx RP and consistent SL LBT failure is triggered for Tx-RP. In one embodiment, SL UE is configured with one or multiple transmission resource pool(s) for performing SL transmission on these transmission resource pool(s). SL UE is also configured with a counter, and a timer, and a threshold for each transmission resource pool, and for consistent LBT failure usage. If UE's MAC layer received LBT failure indication for SL transmission on specific transmission resource pool, start corresponding configured timer for that transmission resource pool. Corresponding configured counter is increased by 1. If a configured counter is larger than a corresponding configured threshold, trigger consistent LBT failure for that transmission resource pool.

In some embodiments, the terminal device 120-1 can cause a lower layer of the terminal device to provide the LBT failure indications to a higher layer of the terminal device 120-1. In other words, each of the LBT failure indications can be provided from a lower layer (for example, the physical layer) of the terminal device 120-1 to a higher layer (for example, a MAC layer) of the terminal device 120-1. In these embodiments, each of the LBT failure indications can contain an indication of an associated resource pool. In some cases, a resource pool index can be indicated in LBT failure indication. LBT failure indication can be labeled with resource pool index(s). In this event, the terminal device 120-1 can start a configured timer(s) for indicated transmission resource pool(s). In the meanwhile, the corresponding configured counter(s) is increased by 1. If corresponding configured counter(s) is equal or larger than corresponding configured threshold(s), a consistent SL LBT failure is triggered for the corresponding transmission resource pool.

As an alternative to the detection granularity of resource pool, the detection granularity of the consistent LBT failure for sidelink transmissions can be based on the BWP. This is novel for SL LBT failure, for example SL-BWP based consistent SL LBT failure. In some embodiments, the terminal device 120-1 can be configured with at least one bandwidth part (BWP) for performing the sidelink transmission. In this event, when determining the number of LBT failure indications, the terminal device 120-1 can count the number of LBT failure indications per BWP. In other words, the terminal device 120-1 may count the number of LBT failure indications of one or more BWPs of the terminal device 120-1. For example, if multiple BWPs are configured for the terminal device 120-1 to perform the sidelink transmission 125-1, then the number of LBT failure indications can be counted separately for individual BWPs.

Alternatively, in some embodiments where the terminal device 120-1 is configured with at least one BWP for performing the sidelink transmission, the terminal device 120-1 can count the number of LBT failure indications per BWP. In such cases, SL LBT failure indication is counted per-SL BWP, and consistent SL LBT failure is triggered for SL-BWP. In one implementation, SL UE is configured a SL-BWP and performing SL transmission on SL-BWP, and SL UE is configured with a counter, and a timer, and a threshold for consistent LBT failure usage. If UE's MAC layer received LBT failure indication for SL transmission, start corresponding configured timer. Corresponding configured counter is increased by 1. If a configured counter is equal or larger than a corresponding configured threshold, consistent SL LBT failure is triggered for the SL UE.

The second specific aspect of the LBT mechanism for sidelink transmissions is the actions of a terminal device responsive to the detected consistent LBT failure for SLU. As a reference, the action responsive to a consistent LBT failure associated with an uplink transmission is to switch a BWP and trigger RACH if not all BWP triggered consistent LBT failure. Otherwise, the terminal device indicates the consistent LBT failure to upper layer if all BWP triggered consistent LBT failure. In contrast, on sidelink, there is no RACH and, UE action needs to be designed for mode 1 and mode 2 respectively, especially for the case that per-RP LBT failure is detected.

The terminal device 120-1 can report SL LBT failure to a network device (e.g., gNB) 110 or an upper layer. Thus, if consistent SL LBT failure is triggered, new UE behaviors are proposed, for example, reporting to gNB or upper layers, or triggering RRC establishment procedure.

In some cases, where the terminal device 120-1 is configured with at least one resource pool for performing the sidelink transmission, the terminal device 120-1 can cause a lower layer of the terminal device to provide the LBT failure indications to a higher layer of the terminal device. Each LBT failure indication can contain an indication of an associated resource pool.

In an implementation, the indication can be transmitted to gNB for mode 1 if any SL-BWP/Tx-RP is triggered consistent LBT failure. In another implementation, the indication can be provided to the upper layers. An RRC establishment procedure can be triggered for mode 2 if all SL-BWP/Tx-RP are triggered consistent LBT failure and if UE is in RRC IDLE mode. The terminal device 120-1 does not select resource from the transmission resource pool anymore if the terminal device 120-1 is in mode 2 and per-Tx RP detection, until transmission resource pool is reconfigured or after a random back-off time.

In general terms, some actions responsive to the consistent LBT failure associated with the sidelink transmissions 125-1 can be common to both per resource pool detection or per BWP detection of the consistent LBT failure. For example, with reference to FIG. 1, it is assumed that the terminal device 120-1 is in a first mode (for example, Mode 1) in which a resource for the sidelink transmission 125-1 is scheduled by the network device 110. In this situation, if the sidelink consistent LBT failure is detected by the terminal device 120-1, the terminal device 120-1 can transmit a report associated with the sidelink consistent LBT failure to the network device 110. In this way, the consistent LBT failure associated with the sidelink transmissions 125-1 can be reported to the network device 110 and then can be solved by the network device 110. For example, the report of the sidelink consistent LBT failure can be transmitted to the network device 110 regardless of whether the number of the sidelink LBT failure indications is counted per resource pool or per BWP.

In one embodiment, if the terminal device 120-1 is under mode 1 transmission, the terminal device 120-1 is triggered to report SL LBT failure of the resource pool to gNB. If consistent SL LBT failure is triggered for SL-BWP, the gNB will be indicated if the terminal device 120-1 is in mode 1. In one sub-embodiment, if the terminal device 120-1 is under mode 1 transmission, the terminal device 120-1 is triggered to report SL LBT failure to gNB.

In some embodiments, it is assumed that the sidelink LBT failure indications are counted per resource pool. In this case, the terminal device 120-1 can perform various actions responsive to the detected sidelink consistent LBT failure. For example, if consistent LBT failures are detected for all of the at least one resource pool, the terminal device 120-1 can cause a lower layer of the terminal device to provide a sidelink LBT failure to a higher layer of the terminal device, and cause the higher layer of the terminal device to suspend sidelink signaling radio bearers (SRBs) and data radio bearers (DRBs).

In some embodiment, the terminal device 120-1 can indicate SL LBT failure to upper layer for example RRC layer, if all transmission resource pool has triggered consistent SL LBT failure. RRC layer may suspend all SL SRBs and DRBs.

Additionally or alternatively, if the terminal device 120-1 is in a second mode in which a resource for the sidelink transmission is selected by the terminal device, the terminal device 120-1 can avoid selecting a resource from a resource pool associated with the consistent LBT failure until the resource pool is reconfigured or within a random back-off time.

In some embodiments, if the terminal device 120-1 is in mode 2, it may not select the resource in the transmission resource pool that triggers consistent SL LBT failure. Instead, the terminal device 120-1 can back off a random time before select resource on that transmission resource pool again.

Additionally or alternatively, if the terminal device 120-1 is in the second mode and in an idle state, and that consistent LBT failures are detected for all of the at least one resource pool, the terminal device 120-1 can trigger a radio resource control (RRC) establishment procedure or a random access channel (RACH) procedure with a cause being the sidelink LBT failure.

RRC establishment procedure or RACH can be triggered if the terminal device 120-1 is in mode 2 and in idle and all resource pool has triggered consistent LBT failure, with a new cause for SL LBT failure.

In an implementation, the terminal device 120-1 can trigger RRC establishment procedure and trigger RRC connection establishment, if all transmission resource pool has triggered consistent SL LBT failure, and if the terminal device 120-1 is in mode 2 and no RRC connection is setup. A new cause for RRC establishment can be added for SL LBT failure.

In another implementation, the terminal device 120-1 can trigger RACH procedure if all transmission resource pool has triggered consistent SL LBT failure, and if the terminal device 120-1 is in mode 2 and in idle mode. A new cause for RRC establishment can be added for SL LBT failure.

Additionally or alternatively, if the terminal device 120-1 is in the second mode, and if consistent LBT failures are detected for all of the at least one resource pool, then the terminal device 120-1 can select a resource from an exceptional resource pool for the sidelink transmission. In other cases, the terminal device 120-1 can use exceptional resource pool if all transmission resource pool has triggered consistent SL LBT failure.

Additionally or alternatively, if consistent LBT failures are detected for all of the at least one resource pool, the terminal device 120-1 can suspend the sidelink transmission.

In some embodiments, the terminal device 120-1 can suspend the data transmission/reception in the SL based on unlicensed band for example in RRC layer.

In some embodiments, it is assumed that the sidelink LBT failure indications are counted per BWP and the terminal device 120-1 is configured with one or more BWPs. In other words, the at least one BWP includes one or more BWPs. In this event, the terminal device 120-1 can perform various actions responsive to the detected sidelink consistent LBT failure. If consistent SL LBT failure is triggered for SL-BWP, the terminal device 120-1 can cause a lower layer of the terminal device to provide a sidelink LBT failure to a higher layer of the terminal device. Alternatively, the terminal device 120-1 can indicate SL LBT failure to higher layer (upper layer), for example a RRC layer. For example, the terminal device 120-1 can cause the higher layer of the terminal device to suspend sidelink signaling radio bearers (SRBs) and data radio bearers (DRBs). In addition, the RRC layer can suspend all SL SRBs and DRBs.

If the terminal device 120-1 is in a second mode in which a resource for the sidelink transmission is selected by the terminal device and in an idle state, the terminal device 120-1 can trigger a radio resource control (RRC) establishment procedure or a random access channel (RACH) procedure with a cause being the sidelink LBT failure.

In an implementation, the terminal device 120-1 can trigger the RRC establishment procedure, and trigger RRC connection establishment if the terminal device 120-1 is in mode 2 and no RRC connection was setup. A new cause for RRC establishment can be added for SL LBT failure. In another implementation, the terminal device 120-1 can trigger RACH procedure if the terminal device 120-1 is in mode 2 and in idle mode.

If the terminal device 120-1 is in the second mode, the terminal device 120-1 can avoid selecting a resource from a resource pool for the sidelink transmission within a random back-off time. For example, if the terminal device 120-1 is in mode 2, it will not select resource in the transmission resource pool and the terminal device 120-1 can back off a random time before selecting resource on transmission resource pool again.

Alternatively, if the terminal device 120-1 is in the second mode, the terminal device 120-1 can select a resource from an exceptional resource pool for the sidelink transmission.

As a further alternative, the terminal device 120-1 can suspend the sidelink transmission. In an implementation, the terminal device 120-1 can suspend the data transmission/reception in the SL based on Unsilenced, for example in RRC layer.

The third specific aspect of the LBT mechanism for sidelink transmissions is how the consistent LBT failures for sidelink transmissions are indicated to the network device 110 or an upper layer of the terminal device 120-1. For conventional LBT failure associated with uplink transmissions, the terminal device 120-1 will generate LBT failure MAC CE and report to gNB during RACH or on serving cell that not triggered consistent LBT failure. On sidelink, LBT failure MAC CE can also indicated but the when and where to indicate LBT failure MAC CE needs new design.

Accordingly, some embodiments of the present disclosure propose how to generate SL LBT failure MAC CE, for example when UL-SCH resource available, or during RRC establishment procedure, or after RACH is completed.

In some embodiments, the terminal device 120-1 triggers and generates SL LBT failure MAC CE. In mode 1, the terminal device 120-1 generates SL LBT failure MAC CE if UL-SCH resource is available, or triggers SR for SL LBT failure MAC CE. In mode 2, the terminal device 120-1 generates and reports SL LBT failure MAC CE during RRC establishment procedure or after RACH is completed

In some embodiments, with reference to FIG. 1, it is assumed that the terminal device 120-1 is in a first mode in which a resource for the sidelink transmission 125-1 is scheduled by the network device 110. In addition, it is assumed that the terminal device 120-1 detects a consistent LBT failure associated with the sidelink transmission 125-1. In this situation, if a resource for an uplink transmission from the terminal device 120-1 to the network device 110 is available, the terminal device 120-1 can generate a control element indicating the consistent LBT failure. Then, the terminal device 120-1 can transmit the control element to the network device 110 using the available resource for the uplink transmission.

In this way, the consistent LBT failure can be timely reported to the network device 110 through an available resource for the uplink transmission, thereby reducing the delay of the reporting of the resource for an uplink transmission and thus improving the performance of the sidelink transmissions from the terminal device 120-1. For both the per resource pool detection or per BWP detection of the consistent LBT failure for sidelink transmissions, if the terminal device 120-1 is in mode 1, and if UL-SCH resource available, the terminal device 120-1 can generate SL LBT failure MAC CE. In one embodiment, the terminal device 120-1 is triggered consistent SL LBT failure. If the terminal device 120-1 is in mode 1, and if UL-SCH resources are available for a new transmission and these UL-SCH resources can accommodate the LBT failure MAC CE plus its subheader as a result of logical channel prioritization, the terminal device 120-1 can be triggered to generate SL LBT failure MAC CE.

On the other hand, if no resource for the uplink transmission is available, the terminal device 120-1 can transmit a scheduling request to the network device 110 for the control element. Upon receiving the scheduling request, the network device 110 can allocate resources to the terminal device 120-1 for reporting the consistent LBT failure. As such, the consistent LBT failure can be timely reported to the network device 110 through an available resource for the uplink transmission, thereby reducing the delay of the reporting of the resource for an uplink transmission and thus improving the performance of the sidelink transmissions from the terminal device 120-1. 3. If consistent SL LBT failure is triggered for specific transmission resource pool. 3. If consistent SL LBT failure is triggered for SL-BWP. Otherwise, trigger SR for SL LBT failure MAC CE. If UL-SCH resource is not available, the terminal device 120-1 is triggered to send SR for SL LBT failure MAC CE.

In some other embodiments, with reference to FIG. 1, it is assumed that the terminal device 120-1 is in a second mode in which a resource for the sidelink transmission 125-1 is selected by the terminal device 120-1. In addition, it is assumed that the terminal device 120-1 detects a consistent LBT failure associated with the sidelink transmission 125-1. In this situation, the terminal device 120-1 can generate a control element indicating the consistent LBT failure. Then, the terminal device 120-1 can transmit the control element to the network device 110 during an RRC establishment procedure, after a random access channel (RACH) procedure is completed, or after a radio resource control (RRC) connection is established. In this way, the consistent LBT failure can be timely reported to the network device 110 through an available resource for the uplink transmission, thereby reducing the delay of the reporting of the resource for an uplink transmission and thus improving the performance of the sidelink transmissions from the terminal device 120-1.

For example, if the terminal device 120-1 is in mode 2, it generates and reports SL LBT failure MAC CE during RRC establishment procedure or after RACH is completed. In another sub-embodiment, if the terminal device 120-1 is in mode 2, and if the terminal device 120-1 has triggered RRC establishment procedure and RACH, the terminal device 120-1 will generate and report SL LBT failure MAC CE during RRC establishment procedure for example in Msg3 or MsgA together with RRC connection establishment request message. In this case, if the RACH fails, Msg3/MSGA buffer is not flushed so that SL LBT failure MAC CE can be retransmit in next RACH re-try. In another case, the terminal device 120-1 can generate and report SL LBT failure MAC CE after RACH is completed, or after RRC connection is established.

The fourth specific aspect of the LBT mechanism for sidelink transmissions is the conditions in which a consistent LBT failure can be cancelled for sidelink transmissions. For conventional LBT mechanism in uplink transmission, a consistent LBT failure can be cancelled when LBT failure MAC CE is transmitted, or RACH completed or lbt-FailureRecoveryConfig reconfigured. On sidelink, the cancelling conditions need new designs, especially in the case that RP based LBT failure detection is adopted.

Accordingly, some embodiments of the present disclosure propose new conditions for SL LBT failure cancellation, for example after SL LBT failure MAC CE is transmitted or correctly received, or transmission pool reconfiguration, or RRC establishment procedure is completed.

The terminal device 120-1 can cancel SL LBT failure MAC CE. In some embodiments, the terminal device 120-1 cancels triggered SL LBT failure MAC CE if SL LBT failure MAC CE is transmitted or SL LBT failure MAC CE is correctly received by gNB, or any transmission resource pool is reconfigured, or SL-BWP is reconfigured, or RRC establishment procedure is completed.

In general terms, some conditions for cancelling the consistent LBT failure associated with the sidelink transmissions 125-1 can be common to both per resource pool detection or per BWP detection of the consistent LBT failure. As an example of such a common condition, if a control element indicating the consistent LBT failure is transmitted to the network device 110, the terminal device 120-1 can cancel the consistent LBT failure. As such, since the consistent LBT failure is already reported to the network device 110 and the consistent LBT failure can be considered as to be solved by the network. Accordingly, the terminal device 120-1 can cancel the consistent LBT failure so as to save the resource overhead for maintaining various parameters of the consistent LBT failure.

For example, if SL LBT failure MAC CE is transmitted, SL LBT failure MAC CE is cancelled, in the case that consistent SL LBT failure is triggered for specific transmission resource pool, or consistent SL LBT failure is triggered for SL-BWP. In one embodiment, if SL LBT failure MAC CE is transmitted and no SL LBT failure indication is received for the transmission, cancel all triggered consistent SL LBT failure for resource pool(s) that included in SL LBT failure MAC CE. In one embodiment, if SL LBT failure MAC CE is transmitted and no SL LBT failure indication is received for the transmission, cancel all triggered consistent SL LBT failure.

As another example of such a common condition, if an acknowledgement that the control element is successfully received by the network device is received, the terminal device 120-1 can cancel the consistent LBT failure. In this way, since the consistent LBT failure is already successfully received by the network device 110, the consistent LBT failure can be considered as to be solved by the network. Therefore, the terminal device 120-1 can cancel the consistent LBT failure so as to save the resource overhead for maintaining various parameters of the consistent LBT failure. For example, SL LBT failure MAC CE is correctly received by gNB. In another sub-embodiment, if LBT failure MAC CE is transmitted and HARQ ACK is received from gNB, cancel all triggered consistent SL LBT failure for resource pool(s) that included in SL LBT failure MAC CE. In another sub-embodiment, if LBT failure MAC CE is transmitted and HARQ ACK is received from gNB, cancel all triggered consistent SL LBT failure.

As a further example of such a common condition, if an RRC establishment procedure is completed, the terminal device 120-1 can cancel the consistent LBT failure. Through the RRC establishment procedure, the consistent LBT failure can be considered as being solved. Accordingly, the terminal device 120-1 can cancel the consistent LBT failure so as to save the resource overhead for maintaining various parameters of the consistent LBT failure. For example, RRC establishment procedure is completed. In a fourth sub-embodiment, if the RRC establishment procedure is completed, cancel all triggered SL LBT failure. In a fifth sub-embodiment, if the RRC establishment procedure is completed, cancel all triggered SL LBT failure.

In addition to the conditions common to both per resource pool detection or per BWP detection of the consistent LBT failure, there can be dedicated conditions for cancelling the consistent LBT failure detected per resource pool. For example, with reference to FIG. 1, it is assumed that the terminal device 120-1 is triggered consistent SL LBT failure for specific resource pool. In this event, if the resource pool associated with the consistent LBT failure is reconfigured, the terminal device 120-1 can cancel the consistent LBT failure. Through the reconfiguration of the resource pool, the consistent LBT failure can be considered as being solved. Accordingly, the terminal device 120-1 can cancel the consistent LBT failure so as to save the resource overhead for maintaining various parameters of the consistent LBT failure. In an embodiment, if the transmission resource pool which triggered SL LBT failure is reconfigured, the terminal device 120-1 cancels all triggered consistent SL LBT failure for that resource pool, and stops or resets corresponding configured timer/counter.

Further, in some embodiments, there can be dedicated conditions for cancelling the consistent LBT failure detected per BWP. For example, with reference to FIG. 1, it is assumed that the terminal device 120-1 is triggered consistent SL LBT failure. In some embodiments, if a BWP associated with the consistent LBT failure is reconfigured, the terminal device 120-1 can cancel the consistent LBT failure. Through the reconfiguration of the BWP, the consistent LBT failure can be considered as being solved. Accordingly, the terminal device 120-1 can cancel the consistent LBT failure so as to save the resource overhead for maintaining various parameters of the consistent LBT failure. In an embodiment, if the SL-BWP is reconfigured, the terminal device 120-1 cancels all triggered consistent SL LBT failure, and stops or resets corresponding configured timer/counter.

The fifth specific aspect of the LBT mechanism for sidelink transmissions is the format or content of the control element (for example, a MAC CE) indicating the LBT failure for the sidelink transmission. As a reference, the format or content of the conventional LBT MAC CE for an uplink transmission is generated for different serving cell, which cannot took place on sidelink since there can be only one carrier for sidelink transmission. To address this issue and for other special considerations in sidelink transmissions, some embodiments of the present disclosure propose new SL LBT failure MAC CE format for sidelink transmissions.

In some embodiments, with reference to FIG. 1, it is assumed that the terminal device 120-1 detects the consistent LBT failure associated with the sidelink transmission 125-1 to the terminal device 120-2. In this event, the terminal device 120-1 can generate a control element (for example, a MAC CE) for indicating the consistent LBT failure. Further, the control element can contain an identifier of the terminal device 120-2, namely, a destination terminal device of the sidelink transmission 125-1. In this way, the terminal device 120-1 needs to indicate which link is experiencing the consistent LBT failure, because the terminal device 120-1 can maintain more than one link at a time.

In some other embodiments, it is assumed that the terminal device 120-1 detects the consistent LBT failure per resource pool. In these embodiments, the terminal device 120-1 can generate a control element for indicating the consistent LBT failure. In addition, the control element can contain an indication of a resource pool associated with the consistent LBT failure. In other words, the control element for the consistent LBT failure associated with the sidelink transmission 125-1 can have a resource pool based format if the consistent LBT failure is detected per resource pool. In this way, the consistent LBT failures can be reported to the network device 110 per resource pool, thereby enabling operations per resource pool responsive to the consistent LBT failures on the network side.

For example, if SL LBT failure MAC CE is generated for specific transmission resource pool: SL LBT failure MAC CE contains consistent SL LBT failure indication for different transmission resource pool. SL LBT failure MAC CE contains the information that for which transmission resource pool the consistent SL LBT failure is triggered. For example, for each transmission resource pool that configured for the terminal device 120-1, 1 bit information is to indicate consistent SL LBT failure, if the bit set to 1, means the corresponding resource pool is triggered consistent SL LBT failure. Otherwise, the corresponding resource pool is not triggered consistent SL LBT failure. Alternatively, the corresponding resource pool is not configured for the terminal device 120-1. In one sub-embodiment, one octet MAC CE format is used, which is as following figure.

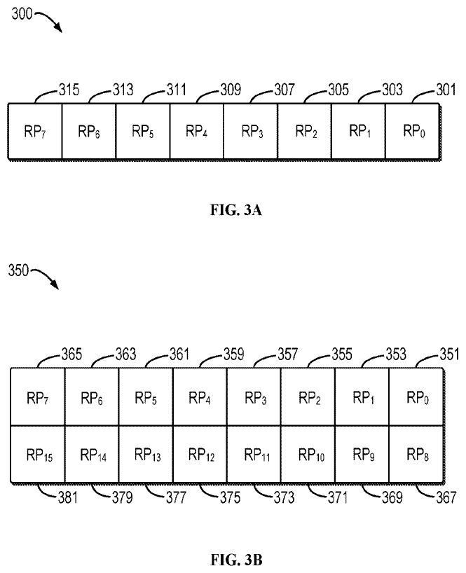

FIG. 3A illustrates an example of a control element 300 for indicating consistent LBT failures per resource pool in accordance with some embodiments of the present disclosure. As shown, in some embodiments, the control element 300 can be an LBT failure MAC CE for sidelink with one octet. Accordingly, the control element 300 includes eight bits 301 to 315 for eight resources pools respectively. More generally, the control element includes at least one bit for the at least one resource pool, respectively, a predetermined value of each bit of the at least one bit indicating a consistent LBT failure associated with a resource pool corresponding to the bit.

For example, the bit 301 can correspond to resource pool 0 (shown as RP0), the bit 303 can correspond to resource pool 1 (shown as RP1), bit 305 can correspond to resource pool 2 (shown as RP2), bit 307 can correspond to resource pool 3 (shown as RP3), bit 309 can correspond to resource pool 4 (shown as RP4), bit 311 can correspond to resource pool 5 (shown as RP5), bit 313 can correspond to resource pool 6 (shown as RP6), and bit 315 can correspond to resource pool 7 (shown as RP7). It is noted that Consider each SL UE has maximally 8 transmission pools (maxNrofTXPool-r16=8) for scheduling pool or UE selected pool, so one octet format is enough. If an exceptional pool is considered, then one more octet is needed.

In some embodiments, the indication of the resource pool is an entry index of the resource pool in a configuration message for configuring the at least one resource pool or is an identifier of the resource pool. Resource pool index can be the entry index of resource pool configuration, or resource pool id. Here RPi means, if there is a transmission resource pool configured for the MAC entity with Transmission Resource pool i as the entries of configured in sl-TxPoolScheduling-r16 or in sl-TxPoolSelectedNormal-r16 and if consistent LBT failure have been triggered and not cancelled in this transmission resource pool, the field is set to 1; otherwise, the field is set to 0.

As an alternative to a single octet format, two octets MAC CE format can be used in embodiments of the present application. FIG. 3B illustrates an example of another control element 350 for indicating consistent LBT failures per resource pool in accordance with some embodiments of the present disclosure.

As shown in FIG. 3B, the control element 350 can be an LBT failure MAC CE for sidelink with two octets. Accordingly, the control element 350 includes sixteen (16) bits 351 to 381 for sixteen (16) resources pools respectively. More generally, the control element includes at least one bit for the at least one resource pool, respectively, a predetermined value of each bit of the at least one bit indicating a consistent LBT failure associated with a resource pool corresponding to the bit.

For example, the bit 351 can correspond to resource pool 0 (shown as RP0), the bit 353 can correspond to resource pool 1 (shown as RP1), bit 305 can correspond to resource pool 2 (shown as RP2), bit 357 can correspond to resource pool 3 (shown as RP3), bit 359 can correspond to resource pool 4 (shown as RP4), bit 361 can correspond to resource pool (shown as RP5), bit 363 can correspond to resource pool 6 (shown as RP6), and bit 365 can correspond to resource pool 7 (shown as RP7).

Similarly, the bit 367 can correspond to resource pool 8 (shown as RP8), the bit 369 can correspond to resource pool 9 (shown as RP9), bit 371 can correspond to resource pool 10 (shown as RP10), bit 373 can correspond to resource pool 11 (shown as RP11), bit 375 can correspond to resource pool 12 (shown as RP12), bit 377 can correspond to resource pool 13 (shown as RP13), bit 379 can correspond to resource pool 14 (shown as RP14), and bit 381 can correspond to resource pool 15 (shown as RP15). Here is to consider that here has maximally 16 resource pool id. Each transmission resource pool (mode-1 pool, mode-2 pool, exceptional pool, and/or the like) will be configured with one resource pool id sl-ResourcePoolID-r16. So two-octet MAC CE can reflect all transmission resource pool for specific UE.

In some embodiments, the indication of the resource pool is an entry index of the resource pool in a configuration message for configuring the at least one resource pool or is an identifier of the resource pool. Resource pool index can be the entry index of resource pool configuration, or resource pool id. In this format RPi means, if there is a transmission resource pool configured for the MAC entity with Transmission Resource pool i, in which RP0˜RP15 represent transmission resource pool id 1˜16. If consistent LBT failure have been triggered and not cancelled in this transmission resource pool, the field is set to 1, otherwise the field is set to 0. For resource pool with id which is not configured for the terminal device 120-1, the field is up to UE implementation. Alternatively, a default value may be set to 0 and the gNB can ignore these fields.

As mentioned above, MAC CE includes the destination UE IDs because the terminal device 120-1 may maintain more than one link at a time. The terminal device 120-1 needs to indicate which link is experiencing the consistent LBT failure. In this case, additional 3 octets need to be added in MAC CE, which represent 24 bits destination id.

SL LBT failure MAC CE contains consistent SL LBT failure indication for different SL-BWP. In some embodiments, with reference to FIG. 1, it is assumed that the terminal device 120-1 is configured with one BWP and the terminal device 120-1 detects a consistent LBT failure associated with the sidelink transmission 125-1 per BWP. In this event, the terminal device 120-1 can generate a control element (for example, a MAC CE) for indicating the consistent LBT failure. Further, the control element can be of a zero bit format. That is, the control element can have no indication bit, since there is only one BWP and the control element itself can imply the consistent LBT failure in the only BWP. In this way, the signaling overhead for indicating the BWP in which the consistent LBT failure occurs can be saved.

In some embodiments, the control element can include a subheader with logical channel identification (LCID) indicating that the control element is for a sidelink LBT failure. In this way, upon receiving the control element, the network device 120 can be aware that the control element is for a sidelink LBT failure. For example, SL LBT failure MAC CE is identified by a MAC subheader with a new LCID, which indicate that this is for SL LBT failure. If the terminal device 120-1 is triggered to report SL LBT failure MAC CE, the subheader is included in MAC PDU.

In another embodiment, as mentioned above, the MAC CE includes the destination UE IDs because the terminal device 120-1 may maintain more than one link at a time. The terminal device 120-1 needs to indicate which link is experiencing the consistent LBT failure. In this case, MAC CE could be a 3 octet format, which include 24 bits destination id.

The six specific aspect of the LBT mechanism for sidelink transmissions is the priority of the control element (for example, a MAC CE) indicating the consistent LBT failure for sidelink transmissions during the Logical Channel Prioritization (LCP). In one embodiment, the terminal device 120-1 is triggered to generate and transmit SL LBT failure MAC CE. During LCP, the priority of SL LBT failure MAC CE needs to be determined. For example, with reference to FIG. 1, it is assumed that the terminal device 120-1 detects a consistent LBT failure for the sidelink transmission 125-1, and generates a control element for reporting the consistent LBT failure to the network device 110. In this situation, if the terminal device 120-1 has multiple control elements including the one indicating the consistent LBT failure for the sidelink transmission 125-1 to transmit to the network device 110, then the terminal device 120-1 needs to determine the priorities of these control elements. As a reference, the conventional LBT MAC CE for uplink transmissions is placed before the buffer status report (BSR) MAC CE. If the new control element (for example, the new MAC CE) for sidelink LBT failure is introduced, the priority of the new control element during the LCP needs new design. Accordingly, some embodiments of the present disclosure propose a new SL LBT failure MAC CE priority.

In some embodiments, the terminal device 120-1 detects a consistent LBT failure associated with the sidelink transmission 125-1 and a consistent LBT failure associated with an uplink transmission to the network device 110. In these embodiments, the terminal device 120-1 can generate a first control element indicating the consistent LBT failure associated with the sidelink transmission. Additionally, the terminal device 120-1 can generate a second control element indicating the consistent LBT failure associated with the uplink transmission. Then, the terminal device 120-1 can determine a first priority of the first control element and a second priority of the second control element. In this way, the terminal device 120-1 can preferentially transmit more important information to the network device 110, thereby improving the performance of the communication system 100.

In some embodiments, the first priority of the first control element can be fixed relative to the second priority of the second control element, regardless of whether the consistent LBT failure for the sidelink transmission 125-1 is detected per resource pool or BWP. For example, if SL LBT failure MAC CE is generated for specific transmission resource pool and is multiplexing with LBT failure MAC CE, the relative priority of the SL LBT failure MAC CE can be constant relative to the LBT failure MAC CE. Similarly, if SL LBT failure MAC CE is generated for SL-BWP and is multiplexing with LBT failure MAC CE, the relative priority of the SL LBT failure MAC CE can be invariable relative to the LBT failure MAC CE.

For instance, the first priority can be fixedly lower than the second priority. In this way, the LBT failure associated with the uplink transmission to the network device 110 can be preferentially reported to the network device 110, thereby ensuring the performance of the uplink transmissions. For example, SL LBT failure MAC CE priority can be fixed for example lower than LBT failure MAC CE. However, in some other embodiments, the priority of SL LBT failure MAC CE can be fixedly higher than LBT failure MAC CE. As such, the LBT failure associated with the sidelink transmission 125-1 to the terminal device 120-2 can be preferentially reported to the network device 110, thereby ensuring the performance of the sidelink transmissions.

In some embodiments, as an alternative to the fixed relative priority, the priority of SL LBT failure MAC CE can be flexible relative to the LBT failure MAC CE information. In other words, in the above disused example, the terminal device 120-1 can flexibly determine the first priority and the second priority according to various situations. More specifically, with reference to FIG. 1, it is assumed that the terminal device 120-1 connects to multiple cells in which the cell 112 is a primary cell. In this event, if the second control element is associated with the primary cell 112 of the terminal device 120-1, the terminal device 120-1 can determine that the first priority is lower than the second priority. For example, SL LBT failure MAC CE priority is lower than LBT failure MAC CE, if LBT failure MAC CE contains SpCell information. In this way, since the LBT failure is occurred in the primary cell 112 of the terminal device 120-1, the LBT failure associated with the uplink transmission to the network device 110 can be preferentially reported to the network device 110, thereby ensuring the performance of the uplink transmissions in the primary cell 112.

On the other hand, if the second control element is unassociated with the primary cell 112, the terminal device 120-1 can determine that the first priority is higher than the second priority. For example, SL LBT failure MAC CE priority is higher than LBT failure MAC CE, if LBT failure MAC CE contains SCell information only. In this way, the LBT failure associated with the sidelink transmission 125-1 to the terminal device 120-2 can be preferentially reported to the network device 110, thereby ensuring the performance of the sidelink transmissions, since the LBT failure is not occurred in the primary cell 112 of the terminal device 120-1 and the terminal device 120-1 can still perform uplink transmissions in the primary cell 112.

### Example Apparatus

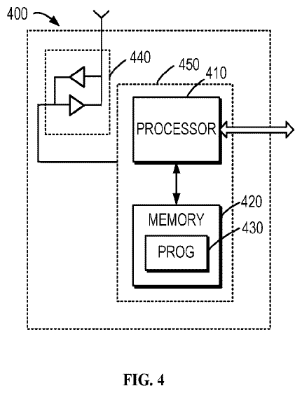

FIG. 4 illustrates a simplified block diagram of an apparatus 400 (also termed as a device 400) that is suitable for implementing embodiments of the present disclosure. The apparatus 400 can be considered as a further example implementation of the network device 110 and the terminal devices 120 as shown in FIG. 1. Accordingly, the apparatus 400 can be implemented at or as at least a part of the network device 110 and the terminal devices 120.

As shown, the apparatus 400 includes a processor 410, a memory 420 coupled to the processor 410, a suitable transmitter (TX) and receiver (RX) 440 coupled to the processor 410, and a communication interface coupled to the TX/RX 440. The memory 420 stores at least a part of a program 430. The TX/RX 440 is for bidirectional communications. The TX/RX 440 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), Uu interface for communication between the eNB and a terminal device, or PC5 interface for communication between two terminal devices.

The program 430 is assumed to include program instructions that, when executed by the associated processor 410, enable the apparatus 400 to operate in accordance with the embodiments of the present disclosure, as discussed herein. The embodiments herein may be implemented by computer software executable by the processor 410 of the apparatus 400, or by hardware, or by a combination of software and hardware. The processor 410 may be configured to implement various embodiments of the present disclosure. Furthermore, a combination of the processor 410 and memory 420 may form processing means 450 adapted to implement various embodiments of the present disclosure.

The memory 420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 420 is shown in the apparatus 400, there may be several physically distinct memory modules in the apparatus 400. The processor 410 may be of any type suitable to the local technical network, and may include one or more of general purpose computers, special purpose computers, microprocessors, digital signal processors (DSPs) and processors based on multicore processor architecture, as non-limiting examples. The apparatus 400 may have multiple processors, such as an application specific integrated circuit chip that is slaved in time to a clock which synchronizes the main processor.

In some embodiments, an apparatus capable of performing the method 200 (for example, the terminal device 120-1) may comprise means for performing the respective steps of the method 200. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 200.

In some embodiments, the apparatus comprises means for starting a listen-before-talk (LBT) procedure. The apparatus also comprises means for generating an LBT failure indication if a channel for a sidelink transmission is occupied during the LBT procedure. The apparatus further comprises means for in response to the number of LBT failure indications being equal to or greater than a predetermined number threshold, determining a consistent LBT failure associated with the sidelink transmission.

In some embodiments, the apparatus further comprises: means for determining the number of LBT failure indications by counting the number of LBT failure indications of at least one resource pool of the apparatus.

In some embodiments, the apparatus further comprises: means for determining the number of LBT failure indications by counting the number of LBT failure indications of at least one bandwidth part (BWP) of the apparatus.

In some embodiments, the LBT failure indication is provided from a lower layer of the apparatus to a higher layer of the apparatus, and the LBT failure indication contains an indication of an associated resource pool.

In some embodiments, the apparatus further comprises: means for in response to determining that the apparatus is in a first mode in which a resource for the sidelink transmission is scheduled by a network device, transmitting a report associated with the consistent LBT failure to the network device.

In some embodiments, the apparatus further comprises at least one of the following: means for in response to determining that the consistent LBT failure is detected for all of the at least one resource pool, causing a lower layer of the apparatus to provide a sidelink LBT failure indication to a higher layer of the apparatus, and causing the higher layer of the apparatus to suspend sidelink signaling radio bearers (SRBs) and data radio bearers (DRBs); means for in response to determining that the apparatus is in a second mode in which a resource for the sidelink transmission is selected by the apparatus, avoiding selecting a resource from a resource pool associated with the consistent LBT failure until the at least one resource pool is reconfigured or reconfigured within a random back-off time; means for in response to determining that the apparatus is in the second mode and in an idle state, and that the consistent LBT failure is detected for all of the at least one resource pool, triggering a radio resource control (RRC) establishment procedure or a random access channel (RACH) procedure with a cause being the sidelink LBT failure; means for in response to determining that the apparatus is in the second mode, and that the consistent LBT failure is detected for all of the at least one resource pool, selecting a resource from an exceptional resource pool for the sidelink transmission; and means for in response to determining that the consistent LBT failure is detected for all of the at least one resource pool, suspending the sidelink transmission.

In some embodiments, the apparatus further comprises at least one of the following: means for causing a lower layer of the apparatus to provide a sidelink LBT failure to a higher layer of the apparatus; means for causing the higher layer of the apparatus to suspend sidelink signaling radio bearers (SRBs) and data radio bearers (DRBs); means for in response to determining the apparatus is in a second mode in which a resource for the sidelink transmission is selected by the apparatus and in an idle state, triggering a radio resource control (RRC) establishment procedure or a random access channel (RACH) procedure with a cause being the sidelink LBT failure; means for in response to determining that the apparatus is in the second mode, avoiding selecting a resource from a resource pool for the sidelink transmission within a random back-off time; means for in response to determining that the apparatus is in the second mode, selecting a resource from an exceptional resource pool for the sidelink transmission; and means for suspending the sidelink transmission.

In some embodiments, the apparatus is in a first mode in which a resource for the sidelink transmission is scheduled by a network device, and the apparatus further comprises: means for in response to determining that a resource for an uplink transmission from the apparatus to the network device is available, generating a control element indicating the consistent LBT failure; or means for in response to determining that no resource for the uplink transmission is available, transmitting a scheduling request to the network device for the control element.

In some embodiments, the apparatus is in a second mode in which a resource for the sidelink transmission is selected by the apparatus, and the apparatus further comprises: means for generating a control element indicating the consistent LBT failure; and means for transmitting the control element to a network device during an RRC establishment procedure, after a random access channel (RACH) procedure is completed, or after a radio resource control (RRC) connection is established.

In some embodiments, the apparatus further comprises means for cancelling the consistent LBT failure in response to at least one of the following: a control element indicating the consistent LBT failure is transmitted to a network device; an acknowledgement that the control element is successfully received by the network device is received; and an RRC establishment procedure is completed.

In some embodiments, the apparatus further comprises: means for in response to determining that a resource pool associated with the consistent LBT failure is reconfigured, cancelling the consistent LBT failure.

In some embodiments, the apparatus further comprises: means for in response to determining that a BWP associated with the consistent LBT failure is reconfigured, cancelling the consistent LBT failure.

In some embodiments, the apparatus further comprises: means for generating a control element indicating the consistent LBT failure and containing an identifier of a destination terminal device of the sidelink transmission.

In some embodiments, the apparatus further comprises: means for generating a control element indicating the consistent LBT failure and containing an indication of a resource pool associated with the consistent LBT failure.

In some embodiments, the control element includes at least one bit for the at least one resource pool, respectively, a predetermined value of each bit of the at least one bit indicating a consistent LBT failure associated with a resource pool corresponding to the bit; or the indication of the resource pool is an entry index of the resource pool in a configuration message for configuring the at least one resource pool or is an identifier of the resource pool.

In some embodiments, the apparatus further comprises: means for generating a control element of a zero bit format indicating the consistent LBT failure.

In some embodiments, the control element includes a subheader with logical channel identification (LCD) indicating that the control element is for a sidelink LBT failure.

In some embodiments, the apparatus further comprises: means for generating a first control element indicating the consistent LBT failure associated with the sidelink transmission; means for generating a second control element indicating a consistent LBT failure associated with an uplink transmission; and means for determining a first priority of the first control element and a second priority of the second control element.

In some embodiments, the first priority is lower than the second priority.

In some embodiments, the means for determining the first priority and the second priority comprises at least one of the following: means for in response to determining that the second control element is associated with a primary cell of the apparatus, determining that the first priority is lower than the second priority; and means for in response to determining that the second control element is unassociated with the primary cell, determining that the first priority is higher than the second priority.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.
1. A method performed by a terminal device, comprising: starting a listen-before-talk (LBT) procedure; generating an LBT failure indication if a channel for a sidelink transmission is occupied during the LBT procedure; and in response to the number of LBT failure indications being equal to or greater than a predetermined number threshold, determining a consistent LBT failure associated with the sidelink transmission.
2. The method of clause 1, further comprising determining the number of LBT failure indications by counting the number of LBT failure indications of at least one resource pool of the terminal device.
3. The method of clause 1, further comprising determining the number of LBT failure indications by counting the number of LBT failure indications of at least one bandwidth part (BWP) of the terminal device.
4. The method of clause 2, wherein the LBT failure indication is provided from a lower layer of the terminal device to a higher layer of the terminal device, and the LBT failure indication containing an indication of an associated resource pool.
5. The method of clause 1, further comprising: in response to determining that the terminal device is in a first mode in which a resource for the sidelink transmission is scheduled by a network device, transmitting a report associated with the consistent LBT failure to the network device.
6. The method of clause 2, further comprising at least one of the following: in response to determining that the consistent LBT failure is detected for all of the at least one resource pool, causing a lower layer of the terminal device to provide a sidelink LBT failure indication to a higher layer of the terminal device, and causing the higher layer of the terminal device to suspend sidelink signaling radio bearers (SRBs) and data radio bearers (DRBs); in response to determining that the terminal device is in a second mode in which a resource for the sidelink transmission is selected by the terminal device, avoiding selecting a resource from a resource pool associated with the consistent LBT failure until the at least one resource pool is reconfigured or reconfigured within a random back-off time; in response to determining that the terminal device is in the second mode and in an idle state, and that the consistent LBT failure is detected for all of the at least one resource pool, triggering a radio resource control (RRC) establishment procedure or a random access channel (RACH) procedure with a cause being the sidelink LBT failure; in response to determining that the terminal device is in the second mode, and that the consistent LBT failure is detected for all of the at least one resource pool, selecting a resource from an exceptional resource pool for the sidelink transmission; and in response to determining that the consistent LBT failure is detected for all of the at least one resource pool, suspending the sidelink transmission.
7. The method of clause 3, further comprising at least one of the following: causing a lower layer of the terminal device to provide a sidelink LBT failure to a higher layer of the terminal device; causing the higher layer of the terminal device to suspend sidelink signaling radio bearers (SRBs) and data radio bearers (DRBs); in response to determining that the terminal device is in a second mode in which a resource for the sidelink transmission is selected by the terminal device and in an idle state, triggering a radio resource control (RRC) establishment procedure or a random access channel (RACH) procedure with a cause being the sidelink LBT failure; in response to determining that the terminal device is in the second mode, avoiding selecting a resource from a resource pool for the sidelink transmission within a random back-off time; in response to determining that the terminal device is in the second mode, selecting a resource from an exceptional resource pool for the sidelink transmission; and suspending the sidelink transmission.
8. The method of clause 1, wherein the terminal device is in a first mode in which a resource for the sidelink transmission is scheduled by a network device, and the method further comprising: in response to determining that a resource for an uplink transmission from the terminal device to the network device is available, generating a control element indicating the consistent LBT failure; or in response to determining that no resource for the uplink transmission is available, transmitting a scheduling request to the network device for the control element.
9. The method of clause 1, wherein the terminal device is in a second mode in which a resource for the sidelink transmission is selected by the terminal device, and the method further comprising: generating a control element indicating the consistent LBT failure; and transmitting the control element to a network device during an RRC establishment procedure, after a random access channel (RACH) procedure is completed, or after a radio resource control (RRC) connection is established.
10. The method of clause 1, further comprising cancelling the consistent LBT failure in response to at least one of the following: a control element indicating the consistent LBT failure is transmitted to a network device; an acknowledgement that the control element is successfully received by the network device is received; and an RRC establishment procedure is completed.
11. The method of clause 2, further comprising: in response to determining that a resource pool associated with the consistent LBT failure is reconfigured, cancelling the consistent LBT failure.
12. The method of clause 3, further comprising: in response to determining that a BWP associated with the consistent LBT failure is reconfigured, cancelling the consistent LBT failure.
13. The method of clause 1, further comprising: generating a control element indicating the consistent LBT failure and containing an identifier of a destination terminal device of the sidelink transmission.
14. The method of clause 2, further comprising: generating a control element indicating the consistent LBT failure and containing an indication of a resource pool associated with the consistent LBT failure.
15. The method of clause 14, wherein the control element includes at least one bit for the at least one resource pool, respectively, a predetermined value of each bit of the at least one bit indicating a consistent LBT failure associated with a resource pool corresponding to the bit; or the indication of the resource pool is an entry index of the resource pool in a configuration message for configuring the at least one resource pool or is an identifier of the resource pool.
16. The method of clause 3, further comprising: generating a control element of a zero bit format indicating the consistent LBT failure.
17. The method of clause 16, wherein the control element includes a subheader with logical channel identification (LCD) indicating that the control element is for a sidelink LBT failure.
18. The method of clause 1, further comprising: generating a first control element indicating the consistent LBT failure associated with the sidelink transmission; generating a second control element indicating a consistent LBT failure associated with an uplink transmission; and determining a first priority of the first control element and a second priority of the second control element.
19. The method of clause 18, wherein the first priority is lower than the second priority.
20. The method of clause 18, wherein determining the first priority and the second priority comprises at least one of the following: in response to determining that the second control element is associated with a primary cell of the terminal device, determining that the first priority is lower than the second priority; and in response to determining that the second control element is unassociated with the primary cell, determining that the first priority is higher than the second priority.
21. A terminal device comprising: a processor; and a memory storing instructions, the memory and the instructions being configured, with the processor, to cause the terminal device to perform the method of any of clauses 1-20.
22. A computer readable medium having instructions stored thereon, the instructions, when executed on at least one processor of a device, causing the device to perform the method of any of clauses 1-20.

Reference to an element in the singular is not intended to mean “one and only one” unless explicitly so stated, but rather is intended to mean “one or more.” Where a phrase similar to “any combination of A, B, C” is used herein, it is intended that the phrase be interpreted to mean that A alone can be present in an embodiment, B alone can be present in an embodiment, C alone can be present in an embodiment, and that any combination of the elements A, B, and C can be present in a single embodiment. For example, any combination of the elements A, B, and C includes the combinations of: A and B, A and C, B and C, and A and B and C can each be present in an embodiment.

When elements, such as A and B, are described as being “A/B” or a “/” is used, then the description is intended to cover all the following combinations: A alone, B alone, or A and B together.

What is claimed is:

1. A user equipment (UE) for wireless communication, comprising:
at least one memory; and
at least one processor coupled with the at least one memory and configured to cause the UE to:
start a listen-before-talk (LBT) procedure;
generate an LBT failure indication if a channel for a sidelink transmission is occupied during the LBT procedure; and
determine, in response to a number of LBT failure indications being equal to or greater than a predetermined number threshold, a consistent LBT failure associated with the sidelink transmission.

2. The UE of claim 1, wherein to determine the number of LBT failure indications, the at least one processor is configured to cause the UE to:
count the number of LBT failure indications of at least one resource pool of the UE.

3. The UE of claim 1, wherein to determine the number of LBT failure indications, the at least one processor is configured to cause the UE to:
count the number of LBT failure indications of at least one bandwidth part (BWP) of the UE.

4. The UE of claim 2, wherein:
the LBT failure indication is provided from a lower layer of the UE to a higher layer of the UE, and the LBT failure indication containing an indication of an associated resource pool.

5. The UE of claim 1, wherein the processor is configured to cause the UE to:
transmit, in response to determining that the UE is in a first mode in which a resource for the sidelink transmission is scheduled by a network device, a report associated with the consistent LBT failure to the network device.

6. The UE of claim 2, wherein the at least one processor is configured to cause the UE to at least one of:
cause, in response to determining that the consistent LBT failure is detected for all of the at least one resource pool, a lower layer of the UE to provide a sidelink LBT failure indication to a higher layer of the UE, and cause the higher layer of the UE to suspend sidelink signaling radio bearers (SRBs) and data radio bearers (DRBs);
avoid, in response to determining that the UE is in a second mode in which a resource for the sidelink transmission is selected by the UE, selecting a resource from a resource pool associated with the consistent LBT failure until the at least one resource pool is reconfigured or reconfigured within a random back-off time;
trigger, in response to determining that the UE is in the second mode and in an idle state, and that the consistent LBT failure is detected for all of the at least one resource pool, a radio resource control (RRC) establishment procedure or a random access channel (RACH) procedure with a cause being the sidelink LBT failure;
select, in response to determining that the UE is in the second mode, and that the consistent LBT failure is detected for all of the at least one resource pool, a resource from an exceptional resource pool for the sidelink transmission; and
suspend, in response to determining that the consistent LBT failure is detected for all of the at least one resource pool, the sidelink transmission.

7. The UE of claim 3, wherein the at least one processor is configured to cause the UE to at least one of:
cause a lower layer of the UE to provide a sidelink LBT failure to a higher layer of the UE;
cause the higher layer of the UE to suspend sidelink signaling radio bearers (SRBs) and data radio bearers (DRBs);
trigger, in response to determining that the UE is in a second mode in which a resource for the sidelink transmission is selected by the UE and in an idle state, a radio resource control (RRC) establishment procedure or a random access channel (RACH) procedure with a cause being the sidelink LBT failure;
avoid, in response to determining that the UE is in the second mode, selecting a resource from a resource pool for the sidelink transmission within a random back-off time; or
select, in response to determining that the UE is in the second mode, a resource from an exceptional resource pool for the sidelink transmission and suspend the sidelink transmission.

8. The UE of claim 1, wherein the UE is in a first mode in which a resource for the sidelink transmission is scheduled by a network device, and the at least one processor is configured to cause the UE to at least one of:
generate, in response to determining that a resource for an uplink transmission from the UE to the network device is available, a control element indicating the consistent LBT failure; or
transmit, in response to determining that no resource for the uplink transmission is available, a scheduling request to the network device for the control element.

9. The UE of claim 1, wherein the at least one processor is configured to cause the UE to cancel the consistent LBT failure in response to at least one of:
a control element indicating the consistent LBT failure is transmitted to a network device;
an acknowledgement that the control element is successfully received by the network device is received; and
an RRC establishment procedure is completed.

10. The UE of claim 2, wherein the at least one processor is configured to cause the UE to:
cancel, in response to determining that a resource pool associated with the consistent LBT failure is reconfigured, the consistent LBT failure.

11. The UE of claim 3, wherein the at least one processor is configured to cause the UE to:
cancel, in response to determining that a BWP associated with the consistent LBT failure is reconfigured, the consistent LBT failure.

12. The UE of claim 1, wherein the at least one processor is configured to cause the UE to:
generate a control element indicating the consistent LBT failure and containing an identifier of a destination UE of the sidelink transmission.

13. The UE of claim 2, wherein the at least one processor is configured to cause the UE to:
generate a control element indicating the consistent LBT failure and containing an indication of a resource pool associated with the consistent LBT failure.

14. The UE of claim 13, wherein one or more of:
the control element includes at least one bit for the at least one resource pool, respectively, a predetermined value of each bit of the at least one bit indicating a consistent LBT failure associated with a resource pool corresponding to the bit; or
the indication of the resource pool is an entry index of the resource pool in a configuration message for configuring the at least one resource pool or is an identifier of the resource pool.

15. (canceled)

16. A processor for wireless communication, comprising:
at least one controller coupled with at least one memory and configured to cause the processor to:
start a listen-before-talk (LBT) procedure for a user equipment (UE);
generate an LBT failure indication if a channel for a sidelink transmission is occupied during the LBT procedure; and
determine, in response to a number of LBT failure indications being equal to or greater than a predetermined number threshold, a consistent LBT failure associated with the sidelink transmission.

17. The processor of claim 16, wherein to determine the number of LBT failure indications, the controller is configured to cause the processor to:
count the number of LBT failure indications of at least one resource pool of the UE.

18. The processor of claim 17, wherein the LBT failure indication is provided from a lower layer of the terminal device to a higher layer of the UE, and the LBT failure indication containing an indication of an associated resource pool.

19. The processor of claim 16, wherein the at least one controller is configured to cause the processor to count the number of LBT failure indications of at least one bandwidth part (BWP) of the UE.

20. A method performed by a user equipment (UE), the method comprising:
starting a listen-before-talk (LBT) procedure;
generating an LBT failure indication if a channel for a sidelink transmission is occupied during the LBT procedure; and
determining, in response to the number of LBT failure indications being equal to or greater than a predetermined number threshold, a consistent LBT failure associated with the sidelink transmission.

21. A user equipment (UE) for wireless communication, comprising:
at least one memory; and
at least one processor coupled with the at least one memory and configured to cause the UE to:
generate a first control element indicating a consistent LBT failure associated with a sidelink transmission;
generate a second control element indicating a consistent LBT failure associated with an uplink transmission; and
generate a first priority of the first control element and a second priority of the second control element.
